(19) United States
(12) Patent Application Publication
(10) Pub. No.: US 2005/0160122 A1
(43) Pub. Date: Jul. 21, 2005

(54) JOINT ADAPTIVE FIXED-POINT REPRESENTATION AND RELATED ARITHMETIC AND PROCESSOR THEREOF

(76) Inventor: Chien-Hua Hsu, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,729

(22) Filed: Jan. 18, 2005

(30) Foreign Application Priority Data
Jan. 19, 2004 (TW) 093101415

(51) Int. Cl. G06F 3/00

(52) U.S. Cl. 708/170

(57) ABSTRACT

A novel fixed-point representation method for representing digital data experiencing an arithmetic transformation. The novel fixed-point representation method includes setting a predetermined number of least significant bits of the digital data as a dynamic shift value, where the dynamic shift value represents a shift-bit number during the arithmetic transformation, and relating a plurality of bits except those occupied by the dynamic shift value in the digital data are set to specific partial bits of the digital data without experiencing the arithmetic transformation, where the specific partial bits include at least a most significant bit containing absolute value information of the digital data.

### BACKGROUND

The invention relates to a novel fixed-point arithmetic and a digital signal processor, and more particularly, to a joint adaptive fixed-point arithmetic which can transform digital data between a fixed-point representation and a joint adaptive fixed-point representation and a related digital signal processor.

In recent years, following the progress of VLSI and computer technology, the ability of immediately processing digital signals has become an urgent demand. Many kinds of digital signal processors (DSP) are therefore invented. The digital signal processors have advantages of high flexibility, high accuracy, and multiple functions. DSPs have many applications, but in reality, no DSP can satisfy all application demands. Designers choose a proper DSP according to its functions, cost, power consumption, difficulty of developing, and integrated degree.

Generally speaking, DSPs are utilized for processing digital data, but different DSPs have different characteristics and are used for different applications. Normal DSPs can be divided into fixed-point DSPs and floating-point DSPs. Those definitions are according to the type of digital data processed by the DSPs and corresponding arithmetic. Fixed point DSPs utilize fixed-point arithmetic and process digital data through fixed-point representation. Fixed point means that the position of the decimal point is fixed. Digital data with the fixed-point representation represents integers or decimal figures between −1.0 and +1.0 according to the position of decimal point. Floating-point DSPs utilize floating-point representation and the value is represented in by way of a mantissa and an exponent such as “mantissa×2^{exponent}”. Floating-point arithmetic is a more complicated arithmetic and can be utilized to evaluate a huge dynamic data range of digital data. Because of advantages of a huge data range and high accuracy, floating-point DSPs enjoy huge market potentials. On the other hand, because of the advantages of low cost and low power consumption, fixed-point DSPs still cannot be ignored in the application of consumer products.

Please refer to FIG. 1, which is a diagram of a fixed-point DSP according to related art. The digital signal processor 10 is utilized to process a plurality of digital data represented in the fixed-point representation. This means that the digital data include two representations of integers and decimals. Additionally, the digital data can be divided into digital data of n bits and digital data of 2n bits according to the occupied bits of the digital data where n is an integer larger than 0. The DSP 10 includes a data receiving end 12, a multiplication circuit 16, a multiplication shifter 18, a first shift device 14, a second shift device 24, a multiplexing arithmetic module 20, a storage device 22, and a data writing end 26.

The data receiving end 12 is used to receive a plurality of digital data of n bits from a memory or other external circuit and used to transfer two digital data each of n bits into the multiplication circuit 16. The multiplication circuit 16 can multiply two digital data of n bits represented in the fixed-point representation to generate digital data of 2n bits represented in the fixed-point representation. Additionally, the multiplication circuit 16 is electrically connected to the multiplication shifter 18. The multiplication shifter 18 properly adjusts the position of the decimal point of digital data of 2n bits according to the integer type or decimal type of digital data to generate a first digital data of 2n bits.

At the same time, the data receiving end 12 transfers digital data of n bits into the first shift device 14. The first shift device 14 processes the digital data of n bits represented in the fixed-point representation through a sign extension to generate a second digital data of 2n bits represented in the fixed-point representation. For example, if an integer of 8 bits (n=8) 00010100 is transformed into an integer of 16 bits (n=16), the higher byte (most significant byte) is filled with 0s (such as from 000101000 to 00000000 00010100). But if a complement is used to represent a negative number, the higher bits are filled with 1s, such as an 8-bit negative integer 11101100 is filled up with 11111111 to get a 16-bit negative integer 11111111 11101100.

The multiplexing arithmetic module 20 includes a multiplexing device 19 and arithmetic unit 21. The multiplexing device 19 is electrically connected to the first shift device 14 and the multiplication shifter 18 for selecting to one digital data of the first or the second digital data. In a real implementation, the multiplexing device 19 can be a multiplexer. The arithmetic unit 21 is electrically connected to the multiplexing device 19 for receiving the selected first or second digital data. The arithmetic unit 21 further includes an output end for receiving a third digital data of 2n bits. Therefore, the arithmetic unit 21 can execute many arithmetic operations on these 2n-bit digital data (such as the first, second, or the third digital data). Then, the arithmetic unit 21 outputs a 2n-bit processed fourth digital data to the storage device 22. The storage device 22 is utilized to store a plurality of digital data processed by the arithmetic module 20. In a real implementation, the storage device 22 can be an accumulator. Finally, the second shift device 24 transforms the 2n-bit digital data with the fixed-point representation into n-bit digital data with the fixed-point representation. The data writing end 26 writes the n-bit digital data with the fixed-point representation in the above-mentioned memory device or other devices.

As the related art mentioned above, although fixed-point DSPs are accepted and used by those skilled in the art, a lot of problems still exist. Many fixed-point DSPs are mainly used in built-in application systems that only have memories with small storage capacities. When the fixed-point DSP 10 in FIG. 1 executes the fixed-point operation with the memory with small storage capacities, quantization errors usually occur because of bit resolution limitations. Please refer to FIG. 1 again where two n-bit digital data are multiplied by the multiplication circuit 16 into a 2n-bit digital data. After a series of processes, if the second shift device 24 has to transform the 2n-bit digital data into n-bit digital data in order to store the n-bit digital data in an n-bit memory and if the 2n-bit digital data is a decimal, the higher n bits of the 2n-bit digital data are preserved, but the lower n bits are ignored so that a quantization error between n-bit digital data and 2n-bit digital data occurs when ignoring the lower n bits.

For example, 48-bit digital data represented in hexadecimal is 0x004444ffffff. If the lower 24 bits are ignored to generate 24-bit digital data, the 48-bit digital data is transformed into 0x004444. After a fixed-point arithmetic is executed, the digital data is transformed into 0x004444000000. Obviously, a huge difference is seen between 0x004444ffffff and 0x004444000000. The difference is termed as the above-mentioned quantization error. The quantization error may cause negative-continuity, distortion, or other bad effects to digital data so that the efficiency of the fixed-point DSP 10 is limited.

In order to reduce the quantization error, the number of bits of a DSP can be increased or floating-point DSPs can be used instead of fixed-point DSPs. However, if the number of bits of a DSP is increased or floating-point DSPs are used instead of fixed-point DSPs, the cost of hardware substantially increases. Additionally, in order to reduce the quantization error, program codes can be re-written. Nevertheless, if program codes are rewritten, it still makes the program codes more complicated and makes the DSPs less efficient.

### SUMMARY

One objective of the claimed invention is therefore to provide a novel fixed-point arithmetic, a novel fixed-point representation, and a DSP that utilizes the novel fixed-point representation to process digital data, to solve the above-mentioned problem.

According to the claimed invention, a novel fixed-point representation for representing digital data experiencing an arithmetic transformation includes setting a predetermined number of least significant bits of the digital data as a dynamic shift value, where the dynamic shift value represents a shift number of bits during the arithmetic transformation and a corresponding plurality of bits except those occupied by the dynamic shift value in the digital data are set to specific partial bits of the digital data without experiencing the arithmetic transformation, where the specific partial bits includes at least a most significant bit containing value information of the digital data.

A method used in a digital signal processor for transforming a high-number-of-bits digital data with fixed point representation into a low-number-of-bits digital data with a novel fixed-point representation includes magnifyingly shifting N bits to the high-number-of-bits digital data with fixed point representation according to the absolute value of high-number-of-bits digital data where N is an integer larger than or equal to 0 and N varies with the absolute value of the high-number-of-bits digital data while ignoring a predetermined number of bits of the high-number-of-bits digital data. Next a dynamic shift value is set to generate the low-number-of-bits digital data with the novel fixed-point representation, where the dynamic shift value corresponds to N.

A method used in a digital signal processor for transforming a low-number-of-bits digital data with a novel fixed-point representation into a high-number-of-bits digital data with a fixed-point representation includes getting a dynamic shift value from the low-number-of-bits digital data and minifyingly shifting N bits to the low-number-of-bits digital data according to the dynamic shift value, where N is an integer greater than or equal to 0.

The claimed invention discloses a digital signal processor for processing at least one digital data, the digital data having a plurality of value representations, the value representations including at least a fixed-point representation and a novel fixed-point representation. The digital signal processor includes at least one extracting/shifting device for transforming a digital data with the novel fixed-point representation method into a digital data with the fixed-point representation; a plurality of representation converters, each representation converter utilizing the novel fixed-point arithmetic to transform at least a digital data between the fixed-point representation and the novel fixed-point representation; and at least an arithmetic unit for executing an arithmetic on the digital data.

In the present invention, a novel fixed-point representation and a novel fixed-point arithmetic are utilized in a DSP and a related arithmetic operation for ensuring that the digital data can reserve more of the most significant bits under the bits resolution limitation so that the accuracy is raised. The present invention novel fixed-point representation is a joint adaptive fixed-point representation based on the related fixed-point representation and many concepts of the floating-point representation. Additionally, corresponding hardware is installed in the DSP for saving more of the most significant bits so that the hardware does not have to utilize less repeating bits to transform a high-number-of-bits digital data into a low-number-of-bits digital data. As a result, when transforming the low-number-of-bits digital data back into the high-number-of-bits digital data, the quantization error can be reduced.

Under the present invention novel fixed-point representation, a predetermined number of least significant bits of the low-number-of-bits digital data are set as a dynamic shift value. The dynamic shift value (in the decimal system) represents the shift number-of-bits that is used to replace the repeating bits of the original high-number-of-bits digital data in the present invention novel fixed-point arithmetic. So, the low bit-number digital data with the novel fixed-point representation can replace the original high-number-of-bits digital data with a high accuracy so that the novel fixed-point representation has a large dynamic range and a lower complexity. This allows the present invention novel fixed-point representation to be accomplished by software and related firmware and further to achieve the advantages of low cost and reducing circuitry resources.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a fixed-point DSP according to the related art.

FIG. 2 is a diagram of digital data with the present invention joint adaptive fixed-point representation.

FIG. 3 is a diagram of an embodiment of digital data in FIG. 2.

FIG. 4 is a flow chart of an implementation according to the present invention.

FIG. 5 is a flow chart of a detail implementation according to the present invention.

FIG. 6 is a flow chart of another implementation according to the present invention.

FIG. 7 is a functional block diagram of a DSP of an embodiment according to the present invention.

FIG. 8 is a functional block diagram of partial devices of the DSP in FIG. 7.

FIG. 9 is a functional block diagram of the DSP in FIG. 7.

### DETAILED DESCRIPTION

The present invention discloses a novel fixed-point representation called a joint adaptive fixed-point representation, and discloses a novel fixed-point arithmetic called a joint adaptive fixed-point arithmetic for efficiently completing a related transformation operation of digital data in a DSP with bit resolution limitations. The present invention joint adaptive fixed-point representation is a novel value representation between the related art fixed-point representation and the related art floating-point representation. The joint adaptive representation is based on the fixed-point representation that represents digital data as integers or decimals between −1.0 and +1.0. The joint adaptive representation further utilizes a plurality of bits as an exponent of the digital data according to the floating-point representation. The exponent, according to the present invention, is called a dynamic shift value, which implies that the dynamic shift value can be used immediately for obtaining a corresponding value without additional operations (such as checking a corresponding table). Other bits of the digital data are called a mantissa.

The basic concept of the joint adaptive fixed-point representation is that in a digital data with the joint adaptive fixed-point representation, the dynamic shift value occupies a fixed number of bits, and the dynamic shift value represented in the decimal system represents a shift-bit number in the present invention novel fixed-point representation. In other words, when the original number is small, a lot of repeating bits occupy higher significant bits of the original number so that more bits are to be shifted. Therefore, the dynamic shift value is set as a larger value in order to replace the repeating bits of the original digital data. On the other hand, when the original number is larger, the dynamic shift value is set as a smaller value.

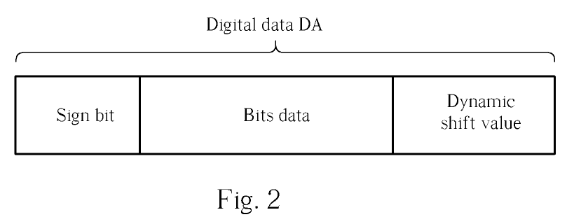

Please refer to FIG. 2, which is a diagram of digital data DA with the present invention joint adaptive fixed-point representation. The digital data DA includes a sign bit, bits data that occupy the most number of bits, and a dynamic shift value. As mentioned above, the number of bits occupied by the dynamic shift value is fixed. The sign bit is the most significant bit of the digital data DA for determining whether the digital data is positive or negative. If the sign bit is 0, the digital data DA is positive and if the sign bit is 1, the digital data DA is negative. If the original number is smaller and the repeating bits of the digital data need to be determined, the bits which follow the sign bit (the most significant bit) and have the same bit value (1 or 0) of the sign bit are selected and set as the above-mentioned repeating bits. Utilizing the present invention's joint adaptive fixed-point arithmetic, a high-number-of-bits digital data with the fixed-point representation is transformed into the digital data DA.

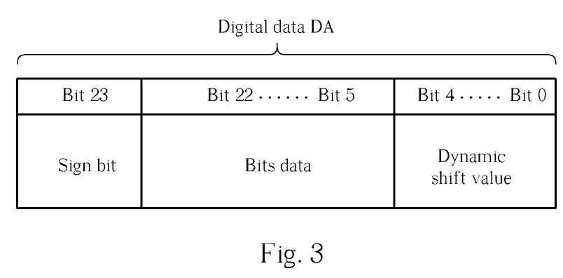

Please refer to FIG. 3, which is a diagram of a detailed embodiment of the joint adaptive fixed-point representation in FIG. 2. The number of bits in the digital data DA in FIG. 3 is 24. The 24 bits in the digital data DA are determined by transforming a high-number-of-bits digital data having a fixed-point representation. In this embodiment, the high-number-of-bits digital data can be 48-bit digital data or any other digital number whose bit number is more than 24. Similarly, the digital data in FIG. 3 includes a sign bit (the most significant bit)(bit 23), a dynamic shift value, which occupies the least significant five bits (bit 0-bit 4), and bits data occupying 18 bits (bit 5-bit 22). The 5 bits of the dynamic shift value (bit 4-bit 0) represent a dynamic range of 0-31. This means that the dynamic shift value can replace at most 31 repeating bits of the digital data of the 48-bit digital data so that the digital data (with joint adaptive fixed-point representation) having a 5-bit dynamic shift value can cover a 50-bit (1+18+31=50) dynamic range.

Additionally, because the dynamic shift value in this embodiment occupies the least significant bits of the digital data DA, compared with the related art floating-point representation which positions the index number on the more significant bits after the sign bit, the present invention dynamic shift value is easily determined, selected from the digital data, and utilized for directly demodulating the shifting bits of the digital data so that the present invention joint adaptive fixed-point arithmetic has lower complexity, and is easily embodied in software.

Please refer to FIG. 3 again when a 48-bit digital data (with the fixed-point representation) is being transformed into the 24-bit digital data DA shown in FIG. 3. First, the joint adaptive fixed-point arithmetic magnifyingly shifts N bits of the 48-bit digital data according to the absolute value of the 48-bit digital data, where N varies with the absolute value of the 48-bit digital data. That is, if the absolute value of the 48-bit digital data is larger, N is smaller, and if the absolute value of the 48-bit digital data is smaller, N is larger. The sign bit is equal to the sign bit of the original 48-bit digital data. When the 48-bit digital data is transformed into a 24-bit digital data with the joint adaptive fixed-point representation, the sign bit is used to compare with the other bits of the 48-bit digital data in order to determine needed shift-bit number (N). After N is determined, a predetermined number of bits of the 48-bit digital data are ignored (in other words, some bits of the 48-bit digital data are retained) and a dynamic shift value corresponding to N is set in order to generate the 24-bit digital data with novel fixed-point representation.

Take a hexadecimal number 0x004444ffffff (where each hexadecimal bit represents 4 binary bits) for example. The above three digits 004 of the hexadecimal number 0x004444ffffff represent 12 binary bits 000000000100, where the most significant bit is the sign bit and the following 8 bits are all 0. Because the following 8 bits are equal to the sign bit (that is, sign bit and the following 8 bits are all 0), 8 bits have to be magnifyingly shifted when the digital data is transformed. Then, in order to transform the 48-bit digital data into a 24-bit digital data, 24 least significant bits have to be ignored. Next, a 5 bits dynamic shift value (01000) corresponding to 8 (bits) are added and installed in the least significant bits of the 24-bit digital data. Therefore, after the 48-bit digital data 0x004444ffffff is magnifyingly shifted 8 bits and 24 bits are ignored from the least significant bit, it becomes 0x4444ff. Then, the least significant 5 bits are replaced by the dynamic shift value (01000). At last, a 24-bit digital data 0x4444e8 with joint adaptive fixed-point representation is generated.

Please note that the number of bits of the dynamic shift value is not limited to 5. In fact, the dynamic shift values shown in FIG. 2 and FIG. 3 are only regarded as a preferred embodiment in the present invention. That is, if the dynamic shift value is changed to be the 4 least significant bits of the digital data, the bit data can occupy another 1 bit (that is, the bit data occupies 19 bits). Therefore, the accuracy of number transformation is slightly raised, and the dynamic range of the dynamic shift value is from 0 to 15 such that the dynamic range of the digital data with 4 bits of dynamic shift value (with the joint adaptive fixed-point representation) can only cover 35 bits. In other words, the present invention can adjust the number of bits of the dynamic shift value to achieve more flexible in real applications. Furthermore, whatever the ignored bits are (such as the ignored 24 bits from the least significant bits in this embodiment), after the digital data is transformed through the joint adaptive fixed-point arithmetic, there is no need to delete the dynamic shift value. In fact, the dynamic shift value can be placed in the digital data.

As discussed above, the present invention joint adaptive fixed-point arithmetic is used to transform a high-number-of-bits digital data with the fixed-point representation into a low-number-of-bits digital data with the joint adaptive fixed-point representation.

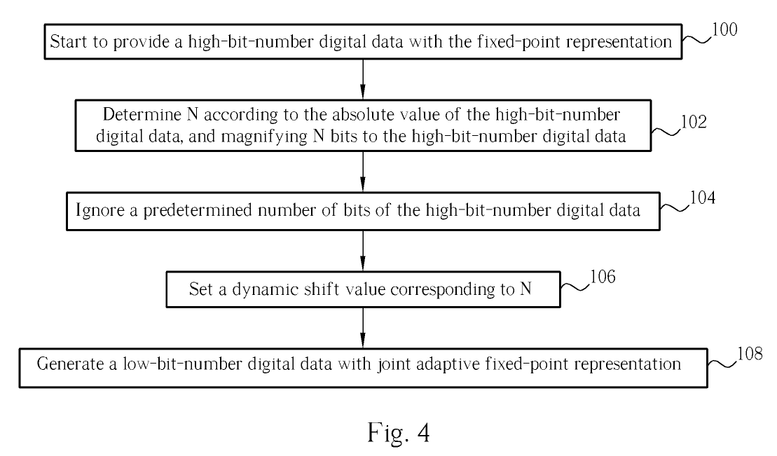

Following the embodiment in FIG. 3, FIG. 4 illustrates a flow chart of an implementation according to the present invention. FIG. 4 comprises the following steps:

Step 100: Start and provide a 48-bit digital data with fixed-point representation. Go to step 102.

Step 102: Determine N according to the absolute value of the 48-bit digital data and magnifyingly shift the 48-bit digital data with fixed-point representation N bits; that is, magnify 2^{N} times the 48-bit digital data with fixed-point representation. Go to step 104. If the absolute value of the 48-bit digital data is larger, N is smaller, and if the absolute value of the 48-bit digital data is smaller, N is larger. This also means that N is a number of repeating bits by comparing a sign bit with the other bits of the 48-bit digital data.

Step 104: Ignore a predetermined number of bits of the 48-bit digital data and retain some bits that comprise at least one most significant bit that contains value information so that the 48 bits digital data, after ignoring the predetermined number of bits, has the same number of bits as the low-number-of-bits digital data. Go to step 106. In this embodiment, the lower 24 bits of the 48-bit digital data are ignored (in other words, 24 bits of the 48-bit digital data are retained to be a 24-bit digital data).

Step 106: Set a dynamic shift value (corresponding to N) to generate the 24-bit digital data with joint adaptive fixed-point representation.

Step 108: The adaptive joint arithmetic transformation from the fixed-point representation into the joint adaptive fixed-point representation is completed.

Please note that in the above-mentioned embodiment, the digital data DA has a 5-bit dynamic shift value, therefore, at most 31 repeating bits can be replaced. Therefore, in step 102, if the number of bits to be shifted is more than 31, the shifting value (N) has to be limited. That is, the method in the present invention has to first predetermine a maximum shifting bit number, which corresponds to the maximum that the dynamic shift value can represent. If N is smaller than the maximum shifting bit number, N is retained. Furthermore, if N is larger than or equal to the maximum shifting bit number, N has to be set as the maximum shifting bit number. Therefore, not all repeating bits of the 48-bit digital data may be shifted in this embodiment. For example, if a 48-bit digital data is 0x000000000007, the needed shifting bit number is 44 (N=44). However, the dynamic shift value has only 5 bits and the maximum shifting bit number is 31. Therefore, at most 31 bits can be magnifyingly shifted, so that the digital data is transformed into 0x000380000000. Furthermore, when 24 bits are ignored from the least significant bits, the digital data is transformed into 0x000380. Lastly, the (maximum) dynamic shift value (11111) is added so that the 24-bit digital data with joint adaptive fixed-point representation is transformed as 0x00039f completely.

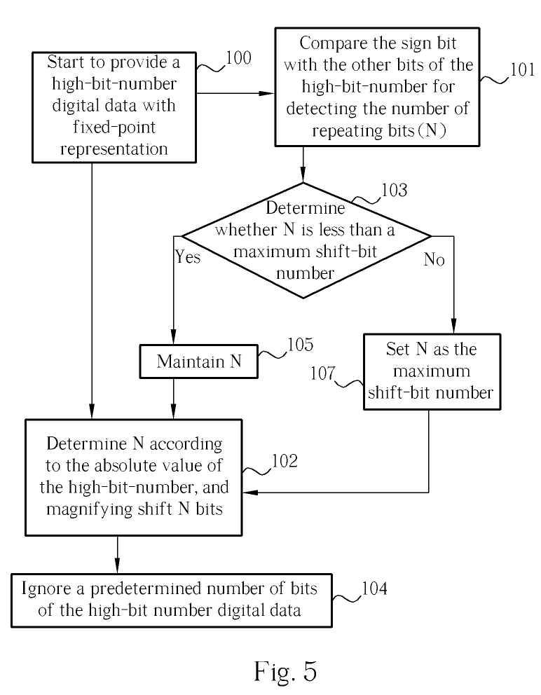

As mentioned above, before step 102, a related determination operation should be executed so that a correct N can be determined. Related steps are illustrated in FIG. 5, which is a flow chart of a detailed implementation of the related determination operation of FIG. 4 according to the present invention. FIG. 5 comprises the following steps:

Step 101: Compare the sign bit with the other bits of the high-number-of-bits (48-bit) digital data to detect the number of repeating bits before step 102 is executed and go to step 103. Please note that N has not been determined yet.

Step 103: Determine whether N is less than a maximum shift-bit number, where the maximum shifting value corresponds to the maximum that the dynamic shift value can represent. If N is less than the maximum shifting value, go to step 105, otherwise, go to step 107.

Step 105: Maintain N if N is less than the maximum shifting value. Go to step 102.

Step 107: Set N as the maximum shift-bit number if N is greater than or equal to the maximum shifting value. Go to step 102.

Therefore, if N is greater than or equal to the maximum shift-bit number (ex: 31), the digital data with joint adaptive fixed-point representation comprises repeating bits (such as above-mentioned 000 of the 24-bit digital data 0x00039f) obtained by the related art sign extension. In other words, the digital data with joint adaptive fixed-point representation only has to comprise at least one most significant bit that comprises value information of the original digital data. For example, if the digital data with fixed-point representation is 0, the above-mentioned “at least one most significant bit that comprises value information of the original digital data” is the sign bit (0), and the above-mentioned value information only has to comprise the sign bit (0). This also means that in this embodiment, if the digital data with fixed-point representation is 0 (the 48-bit digital data is 0x000000000000), the corresponding 24-bit digital data with joint adaptive fixed-point representation is 0x000000 instead of 0x00001 f. This can prevent misunderstanding when the digital data with joint adaptive fixed-point representation is utilized to execute some arithmetic operation.

As mentioned above, the present invention joint adaptive arithmetic transforms a high-number-of-bits digital data with fixed-point representation into a low-number-of-bits digital data with joint adaptive fixed-point representation. Furthermore, the present invention has the ability to transform the low-number-of-bits digital data with joint adaptive fixed-point representation back into the high-number-of-bits digital data with fixed-point representation. Therefore, the present invention has a technical characteristic of transforming digital data between fixed-point representation and joint adaptive fixed-point representation.

Theoretically, in a real implementation, the above-mentioned operation is reversed. That is, in the transformation, a dynamic shift value is determined first, then N bits (N is greater than or equal to 0) is minifying shifted to the low-number-of-bits digital data according to the dynamic shift value, and at last, a predetermined number is filled in the occupied bits of the dynamic shift value (or the original dynamic shift value is utilized) so that the transformation from the joint adaptive fixed-point representation into the fixed-point representation is completed. The shifting operation is further illustrated as follows. When the 24-bit digital data is a decimal between 1.0 and −1.0, before the shifting operation, the original 24-bit digital data is installed in the higher 24 bits of the 48 bits, then the 24 bits digital data is minifying shifted N bits after N is determined. For example, a 24-bit digital data 0x4444e8 (in hexadecimal) represents that 8 bits have been magnifyingly shifted when transformed. Therefore, the 24-bit digital data 0x4444e8 is placed in the higher part of 48 bits field first, ie. 0x4444e8000000, and then minifying shifted the 48 bits 8 bits according to the sign bit (the sign bit is 0). Lastly, the above-mentioned predetermined value (a 5-bit value) is set as 10000b. The 48-bit digital data 0x004444f00000 with fixed-point representation is generated, and if the original dynamic shift value is used, the 48-bit digital data 0x004444e80000 is generated.

The above-mentioned predetermined value is not limited. In the above-mentioned embodiment, the reason that the predetermined value is set as 10000b is that the average of the minimum 00000 . . . 0 and the maximum 11111 . . . 1 in binary is 10000 . . . 0. Therefore, this predetermined value (the most significant bit is 1, the others are 0) can represent the average of ignored bits so that the difference between the ignored value and the original value is reduced. Please note that utilizing the above-mentioned predetermined value or retaining the original dynamic shift value is included in the technical characteristics of the present invention. When the original shifting value is retained, although the dynamic shift value does not belong to the original digital data, because the dynamic shift value lies in the least significant bits, the shifting value does not influence the original data much. When the dynamic shift value is utilized in a digitalaudio-videosignal, a dithering effect contrarily occurs so that a more cantabile music and detailed music can be heard implicitly. Furthermore, the present invention has less complexity, that is, the present invention can be embodied without additional arithmetic operations or hardware. However, if the present invention is not utilized in a digital audio-video signal, the results are undetermined. At this time, a predetermined value can replace the original dynamic shift value and additional arithmetic operation or hardware can be installed.

Comparing 0x4444e8 with the original value 0x004444ffffff, it is easily seen that the value 0x004444f00000 is still a little different from the original value 0x004444ffffff. But if only the related art fixed-point arithmetic is utilized, the 24-bit digital data is transformed back into the value 0x004444000000. Comparing 0x004444ffffff with 0x004444000000, it is seen that the present invention adaptive fixed-point arithmetic can efficiently reduce quantization errors during the transformation operation. Furthermore, because the dynamic shift value represents the shift-bit number, in a real implementation only a small amount of memory is utilized to store and process the digital data so that the accuracy is raisedand there is not need too much additional hardware or software resources. Furthermore, the present invention adaptive fixed-point arithmetic can be implemented by software.

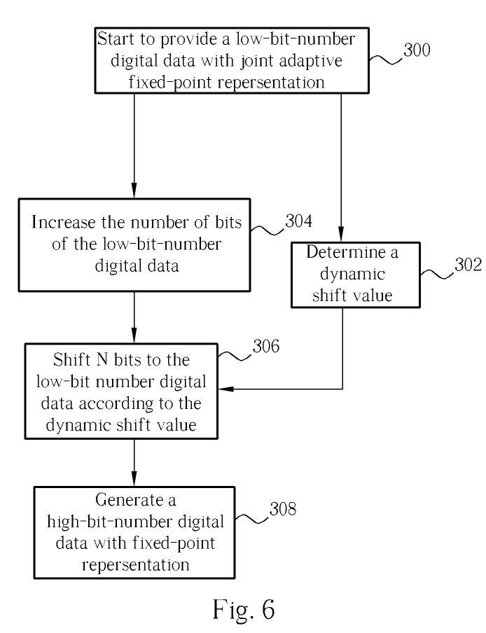

FIG. 6, which is a flow chart of another implementation according to the present invention, illustrates a detailed implementation of transforming a 24-bit digital data with joint adaptive fixed-point representation into a 48-bit digital data with fixed-point representation. It comprises following steps:

Step 300: Provide a 24-bit digital data with joint adaptive fixed-point representation. Go to step 302 and step 304.

Step 302: Determine a dynamic shift value from a predetermined plurality of most significant bits of the 24-bit digital data. Go to step 306.

Step 304: Increase the number of bits of the 24-bit digital data so that the number of bits of the digital data is 48, meaning the original 24-bit digital data is installed inside the 48-bit digital data. When the digital data is a decimal between −1.0 and +1.0, before the shifting operation, the 24-bit digital data can be installed in the 24 most significant bits of the 48 bits. Go to step 306.

Step 306: Shift N bits to the 24-bit digital data according to the dynamic shift value, where N is greater than or equal to 0 and N is the dynamic shift value.

Step 308: Fill a predetermined value up to the occupied bits of the dynamic shift value of the 24-bit digital data or retain the original dynamic shift value for generating a 48-bit digital data with fixed-point representation. Transformation from the joint adaptive fixed-point representation to the fixed-point representation is completed.

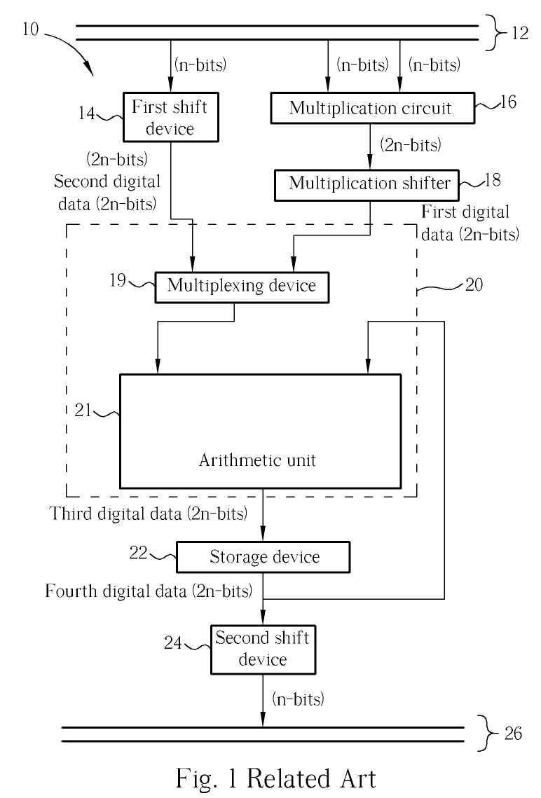

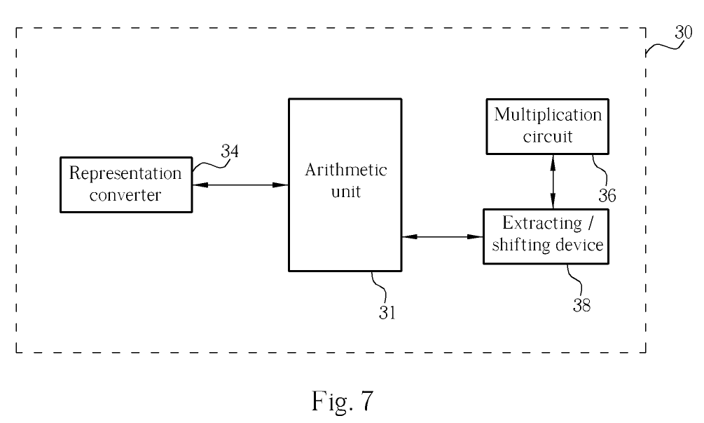

Now that the joint adaptive fixed-point representation and the joint adaptive fixed-point arithmetic according to the present invention are both disclosed, a corresponding hardware structure according to the present invention is disclosed as follows for implementing the joint adaptive fixed-point arithmetic. Please refer to FIG. 7, which is a block diagram of a DSP 30 of an embodiment according to the present invention. As mentioned above, the DSP 30 of the present invention can process both digital data with fixed-point representation and digital data with joint adaptive fixed-point representation. In this embodiment, the digital data can be divided into two kinds of digital data, a high-bit-number digital data (corresponding to the 2n-bit digital data in FIG. 1) and a low-number-of-bits of digital data (corresponding to n-bit digital data in FIG. 1). In a real implementation, the number of bits of the digital data is not limited. That is, the digital data is not limited as the above-mentioned high-number-of-bits digital data and low-number-of-bits digital data.

The DSP 30 comprises a multiplication circuit 36, an extracting/shifting device 38, a representation converter 34, and an arithmetic unit 31. The multiplication circuit 36 can be utilized to multiply two low-number-of-bits digital data for generating a high-number-of-bits digital data. The extracting/shifting device 38 is electrically connected to the multiplication circuit 36 for transforming a digital data with joint adaptive fixed-point representation into a high-number-of-bits digital data with fixed-point representation. The representation converter 34 can utilize the present invention joint adaptive fixed-point arithmetic to transform the received digital data between the fixed-point representation and the joint adaptive fixed-point representation. The arithmetic unit 31 is connected to the extracting/shifting device 38 and the representation converter 34 for executing arithmetic operations on the received digital data. Please note that the received digital data is not limited as being a fixed-point representation or being a joint adaptive fixed-point representation.

Please note that the number of the extracting/shifting devices 38 and the representation converters 34 is not limited. Therefore, each representation converter 34 can be designed for transforming the digital data with fixed-point representation into the digital data with joint adaptive fixed-point representation or for transforming digital data with a joint adaptive fixed-point representation into digital data with a fixed-point representation. Therefore, the representation converter 34 with a specific transformation function can be installed where the specific transformation function is needed inside the present invention DSP 30 and used for receiving and outputting the digital data with joint adaptive fixed-point representation or fixed-point representation. This also means that in the DSP 30 of this embodiment, the connections between the representation converter 34 and other devices are not limited as shown in FIG. 7, where the representation converter 34 is connected to the arithmetic unit 31. In fact, connection of the representation converter can be adjusted according to the process flow of the digital data and other hardware devices.

For example, if users have to transform a high-number-of-bits digital data with a fixed-point representation processed and outputted by the arithmetic unit 34 into a low-number-of-bits with a joint adaptive fixed-point representation in order to write the digital data in an external memory, the representation converter 34 can be designed to be connected to the external memory while having the function of transforming the high-number-of-bits digital data with the fixed-point representation into the low-number-of-bits digital data with the joint adaptive fixed-point representation. Because the joint adaptive fixed-point arithmetic according to the present invention has the technical characteristic of low quantization errors, the transformation error between the low-number-of-bits digital data in the external memory and the original high-number-of-bits digital data is reduced.

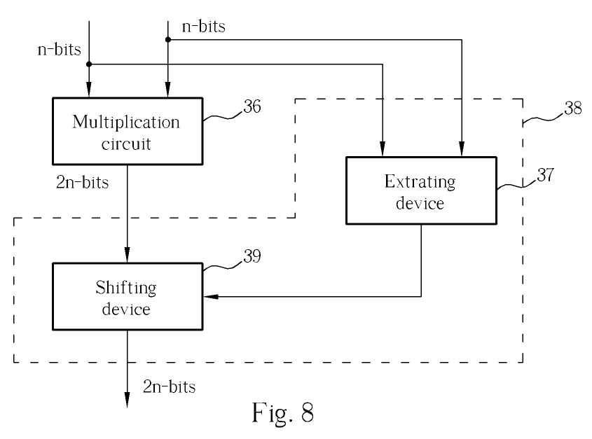

In the DSP 30, devices corresponding to the present invention joint adaptive fixed-point arithmetic are the extracting/shifting device 38 and the representation converter 34. The extracting/shifting device 38 can be divided into an extracting device 37 and a shifting device 39 according to different functions. Please refer to FIG. 8, which is a block diagram of partial devices of the DSP 30 in FIG. 7. The DSP 30 comprises an extracting device 37, a shifting device 39, and a multiplication circuit 36. The multiplication arithmetic according to the present invention can process all kinds of digital data, which comprises digital data with joint adaptive fixed-point representation or fixed-point representation. If two low-number-of-bits (n bits, and n=24 in above-mentioned embodiment) digital data inputted into the multiplication circuit 36 are both in joint adaptive fixed-point representation, before the two digital data with joint adaptive fixed-point representation are multiplied, occupied bits of the dynamic shift value are filled with a predetermined value or the original dynamic shift value is retained as shown in step 308. In the multiplication process, bit data of the digital data and the dynamic shift value can be considered respectively. Therefore, the multiplication circuit 36 can multiply each bit data of the two low-number-of-bits (n-bit) digital data and increase the dynamic shift values. The two low-number-of-bits digital data are also inputted into the extracting device 37 and the extracting device 37 extracts each dynamic shift value of the two digital data so that the related N is determined. Then the related N information is transferred into the shifting device 39 and a corresponding decimal point of the digital data outputted by the multiplication circuit 36 is shifted according to the determined N in order to obtain the high-number-of-bits (2n bits) digital data with fixed-point representation.

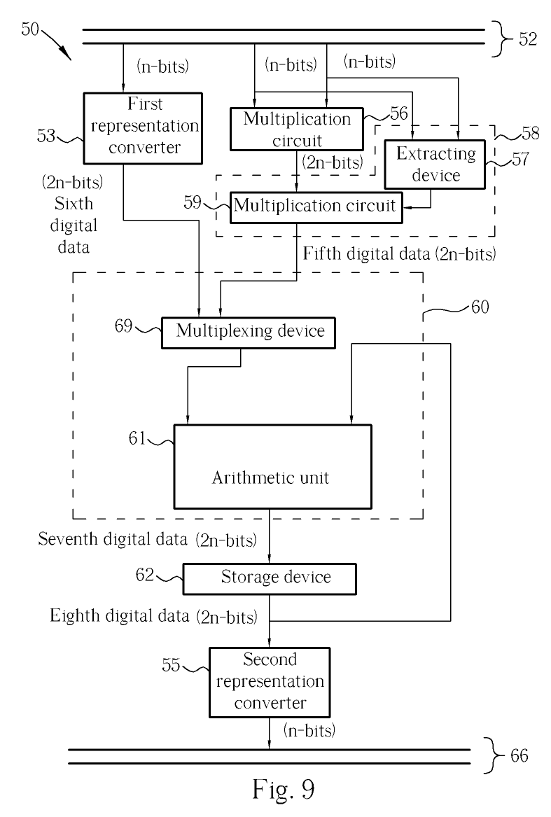

The circuit structure of the embodiment in FIG. 7 is not fixed, but is adjusted according to different demands. Therefore, a DSP with more detailed structure and the corresponding relationships between the joint adaptive fixed-point arithmetic and the hardware are disclosed as follows. Please refer to FIG. 9, which is a functional block diagram of the DSP 50 in FIG. 7 in detail. The DSP 50 in FIG. 9 comprises a data receiving end 52, a multiplication circuit 56, an extracting device 57, a shifting device 59, a first representation circuit 53, a multiplexing arithmetic module 60, a storage device 62, a second representation circuit 55, and a data writing end 66. The data receiving end 52 can receive a plurality of n-bit digital data with joint adaptive fixed-point representation. The multiplication circuit 56 is electrically connected to the data receiving end 52 for receiving two n-bit digital data with joint adaptive fixed-point representation. The multiplication circuit 56 multiplies the two n-bit digital data into a 2n-bit digital data with joint adaptive fixed-point representation. Then the extracting device 57 and the shifting device 59 (can be regarded as an extracting/shifting device 58) process the 2n-bit digital data with joint adaptive fixed-point representation into a 2n-bit fifth digital data with fixed-point representation.

Simultaneously, the first representation circuit 53, which is electrically connected to the data receiving end 52, also receives an n-bit digital data with joint adaptive fixed-point representation and transforms the n-bit digital data into a 2n-bit sixth digital data with fixed-point representation according to the dynamic shift value and sign bit of the n-bit digital data. The multiplexing arithmetic module 60 comprises a multiplexing device 69 and an arithmetic unit 61 where the multiplexing device 69 is electrically connected to the first representation transformation circuit 53 and the shifting device 59 for selecting one of the fifth and sixth digital data. The multiplexing device 69 can be a multiplexer. In addition, the arithmetic unit 61 is electrically connected to the multiplexing device 69 for receiving the selected fifth or sixth digital data (2n-bit digital data) and the arithmetic unit 61 can execute arithmetic on the 2n-bit digital data (the seventh, the first, or the second digital data) with fixed-point representation. Then the arithmetic unit 61 outputs a processed eighth 2n-bit digital data to the storage device 62, which is used to store a plurality of digital data processed by the multiplexing arithmetic module 60. In a real implementation, the storage device 62 can be an accumulator. The second representation transformation circuit 55 can transform the 2n-bit digital data into an n-bit digital data with joint adaptive fixed-point representation, and the data writing end 66 writes the n-bit digital data with joint adaptive fixed-point representation to the storing device 62.

In contrast to the related art fixed-point representation, the present invention joint adaptive fixed-point representation can have the larger dynamic range when maintaining a fixed bit number value information. In other words, the present invention joint adaptive fixed-point representation can reduce the complexity of the related art fixed-point representation; therefore, utilizing software and related firmware easily embodies it. The DSP according to the present invention can utilize less repeating bits to transform a high-number-of-bits digital data into a low-number-of-bits digital data and store the transformation result in a memory. Furthermore, the present invention DSP can accurately and efficiently complete the transformation when transforming the low-number-of-bits digital data back into the high-number-of-bits digital data, and in addition, easily execute the multiplication arithmetic on a plurality of digital data so that the quantization error is reduced without much wasted resources.

Those skilled in the art will readily observe that numerous modifications and alterations of the device may be made while retaining the teachings of the invention. Accordingly, the above disclosure should be construed as limited only by the metes and bounds of the appended claims.

1. A novel fixed-point representation for representing digital data experiencing an arithmetic transformation, the novel fixed-point representation comprising:
setting a predetermined number of least significant bits of the digital data as a dynamic shift value, wherein the dynamic shift value represents a shift bit number during the arithmetic transformation; and
relating a plurality of bits except those occupied by the dynamic shift value in the digital data to specific partial bits of the digital data without experiencing the arithmetic transformation, wherein the specific partial bits comprise at least a most significant bit containing value information of the digital data.

2. The novel fixed-point representation of claim 1 being utilized in a digital signal processor.

3. The novel fixed-point representation of claim 1 wherein the arithmetic transformation is a joint adaptive fixed-point arithmetic for transforming the digital data between in a fixed-point representation and in a joint adaptive fixed-point representation.

4. A method used in a digital signal processor for transforming a high-number-of-bits digital data with fixed point representation into a low-number-of-bits digital data with a novel fixed-point representation, the method comprising:
(a) magnifyingly shifting the high-number-of-bits digital data with fixed point representation N bits according to the absolute value of the high-number-of-bits digital data wherein N is an integer greater than or equal to 0, and N varies with the absolute value of the high-number-of-bits digital data;
(b) after step (a), ignoring a predetermined number of bits of high-number-of-bits digital data; and
(C) after step (a), setting a dynamic shift value to generate the low-number-of-bits digital data with the novel fixed-point representation, wherein the dynamic shift value corresponds to N.

5. The method of claim 4 wherein if the absolute value of the high-number-of-bits digital data is larger, N is smaller; but if the absolute value of the high-number-of-bits digital data is smaller, N is larger.

6. The method of claim 4 further comprising:
(d) in step (a), checking whether N is smaller than a biggest shift-bit number wherein the biggest shift-bit number corresponds to a biggest number that the dynamic shift value can represent; and
(e) in step (a) and after step (d), if N is smaller than the biggest shift-bit number, N is not changed, but if N is bigger than the biggest shift-bit number, setting N be identical to the biggest shift-bit number.

7. The method of claim 6 wherein the digital data with a high-number-of-bits comprises a sign bit, and N is determined by comparing the sign bit with other bits of the high-number-of-bits digital data.

8. The method of claim 7 wherein the low-number-of-bits digital data comprises the sign bit, and the low-number-of-bits digital data with the novel fixed-point representation can be transformed into the high-number-of-bits digital data with the fixed-point representation according to the dynamic shift value and the sign bit.

9. The method of claim 4 further comprising:
(f) after step (c), writing the low-number-of-bits digital data with the novel fixed-point representation in a memory device.

10. A method used in a digital signal processor for transforming a low-number-of-bits digital data with a novel fixed-point representation into a high-number-of-bits digital data with a fixed-point representation, the method comprising:
getting a dynamic shift value from the low-number-of-bits digital data; and
minifyingly shifting the low-number-of-bits digital data N bits according to the dynamic shift value, wherein N is a integer larger than or equal to 0.

11. The method of claim 10 further comprising:
filling a specific value in occupied bits of the dynamic shift value of the low-number-of-bits digital data.

12. The method of claim 10 wherein the high-number-of-bits digital data comprises a sign bit, the method further comprising:
determining the value of each bit of the N bits according to the sign bit.

13. The method of claim 10 wherein the dynamic shift value lies in a predetermined number of least significant bits of the low-number-of-bits digital data.

14. A digital signal processor for processing at least one digital data, the digital data comprising a plurality of value representations, the value representations comprising at least a fixed-point representation and a novel fixed-point representation, the digital signal processor comprising:
at least one extracting/shifting device for transforming a digital data with the novel fixed-point representation into a digital data with the fixed-point representation;
a plurality of representation converters, each representation converter utilizing a novel fixed-point arithmetic to transform at least a digital data between the fixed-point representation and the novel fixed-point representation; and
at least an arithmetic unit for executing an arithmetic on the digital data.

15. The digital signal processor of claim 14 wherein the extracting/shifting device comprises:
an extracting device for extracting a dynamic shift value from the digital data with the novel fixed-point representation; and
a shifting device electrically connected to the extracting device for minifyingly shifting the digital data with the novel fixed-point representation N bits according to the dynamic shift value, wherein N is an integer greater than or equal to 0.

16. The digital signal processor of claim 15 wherein the dynamic shift value lies in a predetermined number of least significant bits of the digital data with the novel fixed-point representation.

17. The digital signal processor of claim 15 wherein each digital data comprises a sign bit and the shifting device determines the value of each bit of N bits according to the sign bit.

18. The digital signal processor of claim 14 wherein the novel fixed-point arithmetic is utilized for transforming a high-number-of-bits digital data with the fixed-point representation into a low-number-of-bits digital data with the novel fixed-point representation, or utilized for transforming a low-number-of-bits digital data with the novel fixed-point representation into a high-number-of-bits digital data with the fixed-point representation.

19. The digital signal processor of claim 18 wherein the novel fixed-point arithmetic magnifyingly shifts the high-number-of-bits digital data with the fixed-point representation N bits according to the absolute value of the high-number-of-bits digital data, ignores a predetermined number of bits, and sets a dynamic shift value to generate the low-number-of-bits digital data with the novel fixed-point representation, wherein N is an integer greater than or equal to 0, and the dynamic shift value corresponds to N and occupies the predetermined number of bits.

20. The digital signal processor of claim 19 wherein if the absolute value of the high-number-of-bits digital data is larger, N is smaller; but if the absolute value of the high-number-of-bits digital data is smaller, N is larger.

21. The digital signal processor of claim 20 wherein if N is smaller than a biggest shift-bit number, N is not changed, if N is bigger than the biggest shift-bit number, N is set to be identical to the biggest shift-bit number.

22. The digital signal processor of claim 21 wherein the biggest shift-bit number corresponds to a biggest value of the dynamic shift value.

23. The digital signal processor of claim 20 wherein the high-number-of-bits digital data comprises a sign bit, and N is determined by comparing the sign bit with other bits of the high-number-of-bits digital data.

24. The digital signal processor of claim 14 further comprising:
a storage device electrically connected to the arithmetic unit for storing at least one digital data; and
a multiplication circuit for multiplying two low-number-of-bits digital data to generate a high-number-of-bits digital data.

25. The digital signal processor of claim 24 wherein the extracting/shifting device is electrically connected to the multiplication circuit, and when the two low-number-of-bits digital data inputted into the multiplication circuit are both in the novel fixed-point representation, the extracting/shifting device transforms the two low-number-of-bits digital data into a high-number-of-bits digital data with the fixed-point representation according to the dynamic values of the two low-number-of-bits digital data.

26. The digital signal processor of claim 14 further comprising:
a data receiving end for receiving at least one digital data; and
a data writing end for writing at least one low-number-of-bits digital data with the novel fixed-point representation in a memory device.

27. The digital signal processor of claim 14 wherein the novel fixed-point arithmetic is a joint adaptive fixed-point arithmetic, and the novel fixed-point representation is a joint adaptive fixed-point representation.
